(19) United States
(12) Patent Application Publication
(10) Pub. No.: US 2023/0146231 A1
(43) Pub. Date: May 11, 2023

(54) SYSTEMS AND METHODS FOR PRODUCTION OF NOVEL TYPES OF COMMEMORATIVE BOOKS

(71) Applicants: Matt Jay JACOBSON, San Francisco, CA (US); John Elijah JACOBSON, San Francisco, CA (US)

(72) Inventors: Matt Jay JACOBSON, San Francisco, CA (US); John Elijah JACOBSON, San Francisco, CA (US)

(21) Appl. No.: 17/986,800

(22) Filed: Nov. 14, 2022

Related U.S. Application Data
(60) Provisional application No. 63/337,181, filed on May 2, 2022.
(60) Provisional application No. 63/278,218, filed on Nov. 11, 2021.

(51) Int. Cl. G06Q 30/06

(52) U.S. Cl. CPC G06Q 30/0621

(57) ABSTRACT

Systems and methods for producing custom commemorative books that employ multiple user interfaces powered by multiple engines to reduce the time, effort and cost associated with production, while producing relevant, high quality, biographical content without overburdening contributors. The systems and methods obtain content without overburdening Contributors and deploy effective writing prompts and templates/skeletons. Additionally, Contributors are assigned to their best-fit assignments and book sections, and appropriate collectable items (swag) are produced based on Contributor data and input. Some embodiments provide a process by which data is collected for the book before, during and after an event. In other embodiments a predeceased lead may initiate a book commemorating themselves, which may be created while the predeceased lead is alive, or may be triggered by a death switch.

### CROSS REFERENCE TO RELATED APPLICATIONS

This application claims priority pursuant to 35 U.S.C. § 119(e) to U.S. Provisional Application Nos. 63/278,218 filed Nov. 11, 2021, and 63/337,181 filed May 2, 2022, which are incorporated herein by reference in their entireties.

### FIELD OF THE INVENTION

This application relates to the field of commemorative books. Specifically, embodiments of the present invention provide systems and methods for employing architecture web components and process and subprocess engines to simplify the production of custom commemorative books.

### DISCUSSION OF THE BACKGROUND

It is prohibitively expensive to write a high-quality commemorative book, with the cheapest services currently costing $3,000 to $9,000, or even more if one hires a dedicated writer.

Even if one succeeds in finding a writer, research is not only onerous, but does not reflect the interests and memories of loved ones, party goers, or those kith and kin who are most interested. One service, LifeWeb360.com attempts to collect memories from the living, but it is “curated” by the company's human staff and thus, lacks the critical time-saving automated processes and is unsurprisingly overburdened and backlogged with orders.

The process of producing commemorative books requires significant skill in typography and layout, enormous and expensive human labor if outsourced or ghost-written, difficult emotional labor and complex politics when it comes to things as trivial as sizing photos or ordering texts.

The Systems and Methods of Automating the Production of Novel Types of Commemorative Books is referred to herein as “LifeBooks.” The LifeBooks process describes a novel method in detail to resolve the shortcomings of failed attempts at making commemorative books by either heavy human labor—which produces books slowly, expensively, and paradoxically of lower quality (as will be elaborated), or some existent semi-automated methods which not only fails to successfully collect and intelligently integrate information from multiple sources, but risks badgering consumers to produce a low-quality product.

The LifeBooks process solves these problems and does better than previous methods, due to its ability to gather a broad collection of information, automatically integrate the information with high-end typography, photo placement and smart formatting that exploits quality analysis of photo and text prominence, thorough appendices, lively opportunities for collaboration, and clever timing to capture events (i.e, the before, during and after versions). The LifeBooks processes ultimately surpasses many dimensions of what could possibly be done by a biographer, writer, or the most committed scrapbooker, and it does so in a fraction of the time for a fraction of the cost.

The LifeBooks process utilizes artificial intelligence (AI), multiple user interfaces (for the lead, contributors, religious professionals, and Guestbooks) and makes the commemorative book making process significantly more advanced than simply printing pictures in a book to service those who want prints of digital pictures.

The outstanding problems facing prior art that the LifeBooks process resolves include (a) eliminating the need for human writers or curators with the explicated automatic book production process, (b) collecting information from kith and kin, (c) quickly doing the impossible single human task of coordinating kith and kin, so each write on the best-fit topics, (d) getting kith and kin to contribute on time, (e) using non-algorithmic methods to draw via hybrid human-machine collaboration the best contributions from contributors, (f) producing a high quality book that employs AI and automation to format, order contributions, and do photo layouts, (g) reducing the emotional and temporal labor (to less than 20 minutes for set-up) on the Client Lead with novel interfaces, and automatic profiling of contributors to facilitate contribution assignments, and (h) implementing never before seen therapeutic elements into the book and more.

The LifeBooks process and variants describe how to recruit content, reduce costs, resolve the endless logistical difficulties of coordinating contributors, evaluating copying, and enabling hybrid proofing, thus outperforming nearly all humans in critical areas of book making.

### SUMMARY OF THE INVENTION

The present invention advantageously provides systems and methods for producing custom commemorative books that employ multiple user interfaces powered by multiple engines to reduce the time, effort and cost associated with producing these books.

It is therefore an object of the invention to be substantially automated to obtain relevant, high quality, biographical content.

It is a further object of the invention to recruit and obtain content without overburdening contributors and to assist the Client Lead (the one who initiates and directs the project) to do so quickly.

It is a further object of the invention to reduce or eliminate emotional labor and avoid initiating family strife.

It is a further object of the invention to deploy the most effective writing prompts and skeletons for contributors, assigning contributors to their best-fit prompts and book sections based on social media, dates of interactions, measured enthusiasm, closeness to Client Lead, simple writing analysis, and contact data.

It is a further object of the invention to generate high-quality commemorative books with features that format media, adjust typography, implement intelligent graphic placement that is sensitive to size and color, and also more complex graphics features (faces, balance, contrast and line density), perform textual analysis to appropriately order contributions, and detect and remove potentially offensive material.

It is a further object of the invention to produce multiple appendices and indices, which are nearly impossible to produce without computational devices.

It is another objective of the invention to generate appropriate accessories (e.g., coffee mugs, commemorative jewelry, etc.) which rely on collecting data from all contributors, polling, and near-real time illustration on the website.

It is another objective of the invention to collect Guestbook contributions via tablet computers from funeral and memorial services.

It is another objective of the invention to inexpensively connect to high-end industrial printers and delivery systems, to rapidly produce and ship books and to protect the privacy of book contents.

It is another objective of the invention to find contributors who the leads and family have lost contact, address memory problems contributors may have and address situations where contributions fail to cover the entire event thus, creating unbalanced books.

It is another objective of the invention to solve problems in assessing contributors for fitness to various tasks and on-time contributions and assist with discovering events and help contributors produce complex and dense information such as graphs and family trees.

It is another objective of the invention to produce from an uploaded video a flip-book animation, with color and contrast adjusted to optimize movement (involving and applying thousands of calculations), and which scientific data shows provides therapeutic benefits for the be-grieved.

It is another objective of the invention to motivate writing by use of a collaborative process that engages the motivators of social proof, peer pressure, and consistency effects (initiated by the voluntary opting to contribute or buy a book and/or a nudging process that reminds contributors and leads of electing to participate).

### BRIEF DESCRIPTION OF THE DRAWINGS

FIGS. 1A-C are a diagrammatic representation of an implementation process for a Lead Set-Up Engine according to an embodiment of the invention.

FIGS. 2A-2B show, respectively, examples of the front and back covers of a commemorative book according to an embodiment of the invention.

FIG. 3 is a diagrammatic representation of the LifeBooks process, according to an embodiment of the invention.

FIG. 4 is a flowchart of a Lead Sign-Up Process, according to an embodiment of the invention.

FIG. 5 is a flowchart of a Contributor Collection Process, according to an embodiment of the invention.

FIG. 6 is a flowchart of a Buyer Process, according to an embodiment of the invention.

FIG. 7 is a flowchart of a Book Creation Process, according to an embodiment of the invention.

FIG. 8 is a diagrammatic representation of a Concurrent Process for weddings and other celebratory events, according to an embodiment of the invention.

FIGS. 9A-9C are diagrammatic representations of Lead Sign-Up process, according to an embodiment of the invention.

FIG. 10 is a diagrammatic representation of a LifeBooks Interface, according to an embodiment of the invention.

### DETAILED DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it should be understood that they are not intended to limit the invention to these embodiments. On the contrary, the invention is intended to cover alternatives, modifications, and equivalents that may be included within the spirit and scope of the invention as defined by the appended claims. Furthermore, in the following detailed description of the present invention, numerous specific details are set forth in order to provide a thorough understanding of the present invention. However, it will readily be apparent to one skilled in the art that the present invention may be practiced without these specific details.

Foundations: Concepts, Key Terms and System Architecture/Process Infrastructure

### Concepts & Key Terms

The novel LifeBooks process produces high quality, custom commemorative books. While we reference the term “books”, it should be understood that LifeBooks refers to a collection of information, however presented, which may include without limitation any one or more of audio, video, written, digital, analog, printed, recorded virtual world data, recorded augmented reality data, data stored on a blockchain, drawings, photographs, and motion capture. While blank book pages can have any organization, and understanding how to automate something that seems impossible to automate requires a serviceable vocabulary with names for the novel components, human and automated, that produce the book. Hence, to understand how users initiate and participate in the process, and how the process and activities are organized, a recitation of terms-of-art is necessary.

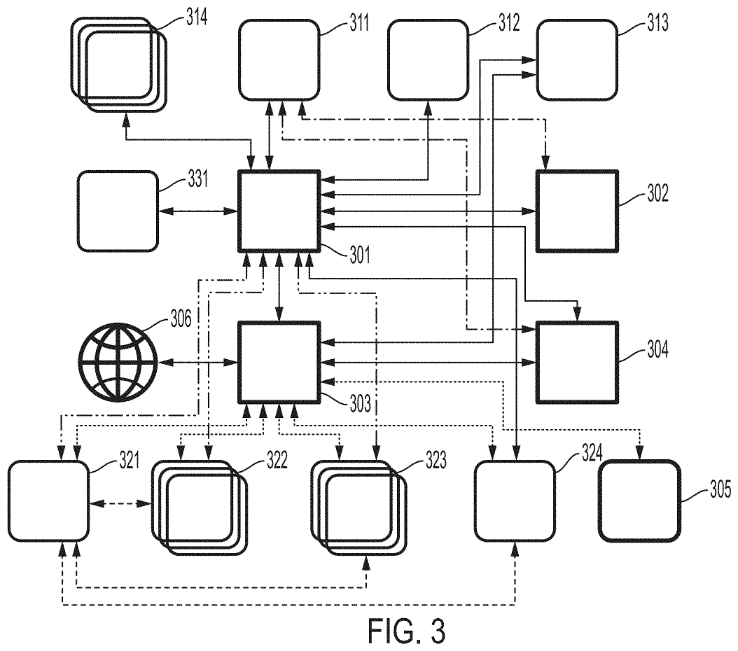

Referring now to FIG. 3, therein is shown the infrastructure supporting the LifeBooks process. The arrows represent data pipelines for transferring data to and from components of the LifeBooks system.

A “Client Lead” 321 is typically a person that initiates the process, and uses a web-app interface to recruit other “Contributors” 322, and interested “Buyers” 323 mostly kith and kin, for memorial and event books (e.g., commemorative wedding books), to contribute “Portions” (not shown in FIG. 3) of the book such as text or images. A Lead Client 321 may also recruit Contributors 322 and Buyers 323 to perform work such as editing assistance.

“Portions” are units produced by Contributors and are distinct from “Sections,” which are the units of the custom book: including the covers, tables of contents, items akin to chapters, image sections, and a flip-book animation. The animation is a “Section” of sequenced images that span nearly the entirety of the book, since the images composing the flip-book can be on nearly every or every-other page. Book “Items” is a term-of-art in this specification varying substantially from ordinary English, and are the elements in sections such as images, texts, and media elements derived from the intelligent and automated extraction of data from Portions, such as a single image. They are the smallest units of the book derived from Contributor contributions.

“Chaplains” 324 are special contributors, usually religious leadership who would contribute eulogies or prayers to many books. The LifeBooks process has methods and “Dashboards” (web-apps or pages) to facilitate Chaplains so they may draw upon the same texts or images on many occasions.

“Buyers” 323 buy the book or swag (i.e., articles or goods commemorating the event), and given the intimacy of LifeBooks, Buyers must obtain permission from the Client Lead to make purchases. Many Buyers are also Contributors. In code, the Client Lead, Contributors, Chaplains, and Buyers constitute a “Group”, and when a book is initiated, a class instance is created with methods and data representations for managing the process producing the Group's custom commemorative book.

A peculiar client-like agent in the architecture is a “Guestbook” 305. Guestbook 305 comprises one or more dashboards belonging to a Group displayed on a computer or computer tablet at an event to connect signatures and notes, just as paper guestbooks do at weddings and funerals, except Guestbooks capture Portions that the LifeBooks process transforms into Items and Sections for the group's LifeBooks.

A kind of lead in some cases of memorial books, is a “Pre-Deceased Lead” who may initiate a book commemorating themselves and designates another as the Client Lead or selects an ordered list, in case a designated Client Lead cannot or declines to be the lead or is a derelict lead (one who fails to compete an order in 1 year). These categories of LifeBooks can be created while the Pre-Deceased Lead is alive or may be triggered by a death-switch.

The relationship of the Client Lead to the event or person commemorated constitutes a criterion determining the book type: (i) “Regular,” where the Client Lead is closely related to the book subject (and acts as a Client Lead, as described in “Lead Dashboard” section below); (ii) “Fan Books,” which are tributes to celebrities or notable persons; and (iii) “Celebrity Books,” written about and authorized by notable persons.

System Architecture/Process Infrastructure

Referring still to FIG. 3, the solid arrows represent general communication, primarily in JavaScript Object Notation (JSON), but may also be in other protocols. For reliability, large files (e.g., larger than approximately 4 mb), sent back and forth (e.g., to Cloud Storage 302) are segmented using a variety of open-source methods, or transferred (typically from the Web/App Front End 303) with large file transfer protocols or using Bubble.io APIs.

Dash-dot-dash arrows represent lines of communication (typically coordinated by the Printer Servers' (311) application programming interfaces (APIs) or in-house printer APIs to enable transfer of completed books and printer servicer/printer related data).

Dot-dot-dash arrows represent emails or direct messages (e.g., direct from Engine 301).

Dashed arrows represent emails or direct messages from Client Lead 321, at times produced and written partially or wholly by the Lead Set-up Engine via the Lead Dashboard (both described below) but sent via Client Lead 321 to avoid spam traps. To avoid spam filters, the first invitation email (or text message) is sent from the Client Lead's email client. The Client Lead may click on a button that activates multiple html address elements (<address>). In the unlikely event security protocols prevent such multiple address activation, a mass email is shown with addresses which the user can copy and paste into emails.

Dotted arrows connect Client Leads 321, Contributors 322, Buyers 323, Chaplains 324 and Guestbooks 305 to the appropriate Web/App Front End 303 dashboards and/or user interfaces.

The LifeBooks central infrastructure system supporting the LifeBooks process generally comprises: (i) one or more Engines 301; (ii) Cloud Storage 302; (iii) a Web-App Front End 303; (iv) a Database (e.g., MySQL) 304; and (v) a Computer/Tablet or other pluggable accessory 305. The Web-App Front End 303 may be on Bubble.io or another server platform and may be in another language (e.g., Flutter and Dart or JavaScript). The one or more Engines 301, Storage 302, and Database components may run off Google Cloud services, or other service providers.

“Engines” 301 are complex sub-processes which enable the LifeBooks Process to work. Some engines have “Sub-Engines,” (not shown in FIG. 3) which can be thought of as sub-sub-methods of the LifeBooks process and are detailed herein so far as is necessary to explicate how the LifeBooks process is performed, or because they enable novel, non-obvious sub-processes which contribute to book quality, ease of interaction, and/or service other customer interests.

Engines 301 are the repository of non-front end dynamic code written typically in Python 3.x, and GBash, with code packaged in Docker or, when appropriate, Kubernetes on, typically, “a bare metal box.” Server particular languages and load balancing technology is in flux and similar systems may be utilized. Engines 301: (a) produce the digital versions of the LifeBooks using (typically) Python to control LaTex engines; (b) play a role in aiding contributors with writing tasks using a variety of editing code deployed gently for the special case of guiding specific contributors; (c) run web-bots; (d) coordinate direct messaging including email communications with Lead Clients; (e) run APIs for printer services and webbots used for marketing and interactions with swag producers; and (f) runs the bulk of the automated portions of LifeBooks process, excepting those processes run in the Web-App Front End 303, and in the minds of users. These include the engines enumerated below (and described throughout the specification), including the Book Creator Engine, Nudge Engine, etc.

Cloud Storage 302 is employed because books and videos have large file sizes, JSON cannot easily handle large data volumes, and fast easy access from code on the Engine promotes efficiency. Thus, Cloud Storage 302 is typically with the same Cloud service provider as Engines 301.

Web-App Front End 303 is typically a JavaScript based front-end to provide state-of the art graphics and a swift user interface (typically, Bubble.io services). The Web-App Front End 303 hosts Dashboards, which mainly collect data, but also perform computations to alter the interface and do minor “back-end” tasks that do not require back-end services (e.g., present pages, collect user data, encrypt and decrypt user data, connect to payment plug-ins (e.g., SLIDE™, or other payment processors), manage Groups, intra-group communication and the “pages” which are interfaces for Guestbooks, and organize and display the entrance of the pipeline for the LifeBooks Process. Heavier back-end services are coded (typically in Python running on a Google Compute Engine), but which, of course, could run in any adequate language on any device connected to the internet. Typical embodiments utilize a Cloud service with a Compute Engine to run code and cloud storage to hold data. The backend typically comprises Google Cloud services and MySQL to perform tasks that are difficult to implement on a front end (e.g., running complex computations or transforming large amounts of data, such as generating the book, enhancing an animation, or sending complex data transformations to the front end such as the outputs of a grammar and style checker.

Web-App Front End 303 also, as a component or extension of various engines (important among these is the Contributor Assistant) presents a rich supportive writing guidance and editing tool, split screens, and outliners. Some front-end services require back-end data. Such front-end services that use heavy back-end computing, running, in this instantiation, on GOOGLE's Compute Engine and GOOGLE CLOUD, include dashboard updates showing images of books, book progress, nudges, or coordinating and integrating of complex direct message email, complex verification, web scraping, swag APIs with swag image generation, connection to printers, and, most importantly, mediating hybrid human-machine proofing and final editing which shows a book produced by the Book Creator Engine.

Database (typically MySQL) 304 handles light data coming to and from Engines 301 and Web-App Front End 303. Light data includes actual data feeds, such as group and individual names, account numbers, cryptographic values.

Other components of LifeBooks system include Printer Servers 311, Shipping Servers 312, Payment Processors 313, and Swag Sellers 314.

Client Lead 321, Contributors, 322, Buyers 323, and Chaplains 324 are group members interacting through the mediated Web-App Front End 303 or, at times, direct messages and emails.

As indicated above, Guestbook 305 comprises one or more dashboards belonging to a Group displayed on a computer or computer tablet at an event to connect signatures and notes.

Social Networks (SNs) and Databases 306 are utilized for acquiring information about users, facilitating contact information, checking for obscene material and other functions as described below, and ad services (targeted or otherwise).

Administrator Dashboard 331 provides access to administrators to process output useful to employees through specially created dashboards. However, the bulk of Administrator contact with the process and its improvements is via coder connection with systems, that is while the Administrator Dashboard provides frequently used data and operations to facilitate Administrators with a user interface that doesn't require coding expertise to do things such as verify identities and perform basic support services, complex Administrator involves coder connection to systems because it involves modifying code on the Cloud services Compute Engine or modifying the website by re-coding or redesigning on Bubble.io.

Web-App Front End Components

Dashboards, hosted by Web-App Front End 303, are interactive webpages or web-apps that mediate most interactions with Group members. However, occasionally for special items (e.g., a single question resulting from an alert), a simple webpage mediates the interaction. A list and descriptions of the Dashboards follows.

The Lead Dashboard interfaces with the Client Lead 321 who initiates the LifeBooks production and purchasing. In typical embodiments, a potential Client Lead uploads a copy of an obituary containing the potential Client Lead's name, an ID confirming the potential Client Lead's identify, and signs a declaration as to the Client Lead's relationship to the book's subject. The Client Lead 321 is generally referred to here as a single individual, but more than one individual (e.g., a close couple) could theoretically be running the Lead Dashboard (see “Lead Clash Sub-Engine section below). From a system point of view, beyond alternative embodiments, which allow at a superficial interface level for multiple leads, the Client Lead 321 is an individual. Client Lead 321 determines the initial Contributors 322 and the Buyers 323 for the book and for non-book items.

The Lead Dashboard is designed for speed. The lead dashboard signs-up the Client Lead 321, sets up a password, and activates a Lead Set-Up Engine, which in addition to collecting information, runs numerous checks (e.g., detecting and solving clashing lead situations where multiple leads sign-up for the same book subject, age checking, and demanding the identification of parents/guardians for contributors under age 13). The Lead Dashboard then guides the Client Lead 321, typically in less than 20 minutes, through: (i) selecting contributors and buyers; (ii) assigning suggested portions to contributors; (iii) designating a chaplain (if desired); and (iv) dispatching mass emails or direct messages sent from the Client Lead's direct mail address(es) to avoid spam traps. To achieve this end and be true to LifeBooks' “this is not scrapbooking motto,” there are specific dashboard and sign-up engine features deployed in combination to achieve a novel, easy, and speedy rallying of kith and kin.

The Lead Dashboard sells the minimum book purchase (e.g., one to five purchase, tracks contribution flow, offers a one-stop shop for monitoring progress on content volume and balance, adds buyers and contributors or closes the group to additional buyers and contributors, makes re-assignments, dismisses contributors, messages group members, and engages in manual nudging. Client Leads are encouraged to provide demographic information and contribute during the contribution phase a general obituary and obituary image (for a memorial book).

The Lead Dashboard further mediates an approval process after contributions are in, including uploading or selecting animations (submitted by others), optional page re-arrangement, optional selection of best quotes and images from contributors and the Prominence Engine (described below), and light editing. To reduce workload. the Client Lead merely deletes one or more portions of contributions or can send Contributors notes for improvement. The Lead Dashboard may also have more advanced previewing and has a “print” button to activate the process's print system.

Contributor Dashboards allow access to support and optional in-group communication. Strictly speaking, Contributor Dashboards are non-lead Contributor Dashboards, because the Client Lead is a Contributor, but has his or her own Lead Dashboard. Client Dashboards provide the interface for those contributing to the book in any of the media types accepted.

Beyond the ubiquitous login and personal information take-in, Contributor Dashboards show assignments, which the Contributor can accept or may propose to do one or more other assignments. Other assignments proposed by Contributors initiate a lead alert so that the Client Lead is informed of all proposed assignments and, in some instances, can approve such proposals. The Contributor Dashboard also may allow messaging to other Contributors and give social proof data on group progress. Importantly, since some Contributors are uncomfortable with writing, it provides prompts, skeletons to flesh-out, and writing guidance to help the Contributors. And, when the Contributor is done writing, it brings the Contributor to an interactive Proofing and Text Improvement Dashboard. Contributors can also mark photos of their own or possibly from an accumulating library to be placed next to their story (as long as it does not conflict with the positioning of another Contributor who did the same and/or would result in the same photo adjacent to two text pieces). There is a “done” button when the Contributor is finished, which initiates an update to the Lead Dashboard and optional direct message or email to the Client Lead, and a thank you note to the Contributor.

To ensure minimum print orders are met, Contributor Dashboards also allow purchase of copies of the LifeBooks and swag, and let the Contributor know if they were designated as a likely purchaser by the Client Lead. When uploading photos or texts, Contributor Dashboards offer opportunities to rank photos, and include a textbox for the best quote. In some instances, the best quote may be shared and voted upon by other group members for cover photos and swag, including personal swag for the Contributor, and the Prominence Engine informed of the outcome of the vote.

Contribution types selected produce text-boxes and dropdown menus for titles, dates, captions, meta-data and contexts. In some cases, such as a timeline or family tree, the dashboard displays the appropriately constrained and helpful interface for filling it out. To aid speed, if multiple images are uploaded at a time, they are displayed for the Contributor to provide in a batch the relevant captions and meta-data, with helpful displays such as automatic age calculation when a year is given. Facial recognition is a developing feature. And, feedback to help balance the temporal spread and diversity of photographic types may be provided. Also, information from other contributors is displayable on the dashboard. These include messages sent through Bubbl.io's inter-group messaging, and also surveys of quotes, questions and feedback inquires for development.

An interactive Writing Assistance Dashboard may have a split screen with advice drawn from an analysis of a contribution by a Contributor, and in some instances may suggest personality and portion-appropriate advice to augment browser spelling and grammar checks. Via a cyborg-like interplay with the Writing Assistance Dashboard, the Contributor is prompted to make the best contributions to the LifeBooks process.

Buyer Dashboards make available products to customers who are not leads nor contributors, but who are permitted to purchase books or swag sold and authorized by LifeBooks. In some instances, Buyers may also request to be contributors through the Buyer Dashboard.

In ordinary cases, the Client Lead, Contributors, and other connected individuals (e.g., non-contributor friends, relatives, Chaplains, etc.) constitute the Buyer-Group for a LifeBooks. The Client Lead ultimately authorizes who can enlarge the Buyer-Group, or individually authorize or de-authorize membership in a LifeBooks Buyer-Group. Also, a Client Lead may define subsets of Buyer-Groups with differential access to the LifeBooks, and in some cases may generate Buyer-Groups for supplementary materials only (e.g., swag) because the lead may want to limit access to the intimacies of the LifeBooks.

The LifeBooks process also comprises a Chaplain Dashboard and a Chaplain Engine. A Chaplain is a general term for a religious professional who would contribute to multiple persons' events, such as funerals and weddings. The Chaplain Dashboard allows these religious professionals to save and retrieve data on their own computers or personal cloud storage systems for easy reuse of eulogies, wedding speeches, religious icons, their own names, and other user-define data categories. However, privacy rules do not allow the LifeBooks process to hold this personal data in the LifeBooks' cloud. Encryption services can aid the Chaplain's local storage of information with passwords the Chaplain individually manages and offers Chaplains basic information on the subject(s) gleaned from Contributions, because sometimes flocks are large or the subject of a particular LifeBooks is not known (or not well-known) by the Chaplain.

In some instances, Chaplains may be asked to verify their identities, via the Chaplain Engine or human support emails. In some instances, Chaplains are only asked to verify their identities if there are complaints of possible unauthorized individuals. Client Leads may also identify Chaplains on the Lead Dashboards.

Some Contributors called to write in many commemorative books will be identified as Heavily Subscribed Contributors. These may include popular social network nodes, but also religious professionals asked to write for numerous commemorative sacraments. These individuals can self-identify or in some instances may be detected by LifeBooks and may be provided dashboard services for saving and reusing texts. In addition, the Heavily Subscribed Contributors may be provided flags if the same Buyer-Group or significant subset thereof is fed nearly identical text, which avoids, for example, insulting duplications of eulogies, and encourages better, more diverse, content. The flags are not merely prompts but pre-written portions or portion parts for the Contributors to use on their Dashboards (e.g., fill-outers, lists, topic sentences and sub-topical sentences with options to assist writing.

Printers and Delivery Services Dashboards can be used to aid those in production facilities when direct messaging and application programming interface (API) services are inadequate or inconvenient, and individuals at these facilities need to review, print or integrate multiple orders or more information than can be usefully exchanged by direct messaging.

Administrator Dashboards provide one of several interfaces into information from any source, ranging from information on the cloud, the Compute Engine, and emails to the company, and can make modifications to any of these sources. It is created for common administrative tasks and designed for administrators who do not have coding expertise. It will display survey, market data, market research, order quantities and types, emails to LifeBooks (the company) and other useful in-house services for employees such as verifications and checks that at the moment require a human hand or are helped by human interventions, such as responding to support inquiries. Administrator Dashboards typically require two-factor authentication and are tightly controlled.

Special Site Pages are typically simple pages (but behind which may be complex engines) that are utilized primarily to resolve disputes, where it may be appropriate and more convenient to do so. Generally, Client Leads, Contributors, or in some cases Buyers or Chaplains (or potential Client Leads, potential Contributors, potential Buyers or potential Chaplains) are emailed links to these special site pages, which perform tasks such as resolving Client Lead clashes (more than one Client Lead), alert individuals or groups of legal violations (e.g., copyright infringements), collect data to authenticate celebrity relationships, alert individuals of obscene or other objectionable material which must be immediately removed, or alert individuals to actions required by law.

The Children's Online Privacy Protection Act (COPPA) compliant page requires parent/guardian of a child Contributor to provide a credit card number which is nominally charged and re-reimbursed so children under 13 cannot fake identity, (e.g., by pressing an “I'm older than 12 year old” button). Client Lead compliance checkers automated by the Age Checker Engine and Age Checker Dashboard require Client Leads to be over 12 years old and identify parents who are then directed to the relevant special page for granting permissions. The Age Checker Engine may also ensure that meta-data on children is not collected.

Policy Compliance Checker produces the special pages described below for collecting ID information, such as uploaded Driver's Licenses and obituaries when celebrity detection is flagged, under which case either a fan book is generated or a book for a verified kith or kin of a celebrity is made; or to alert users of policy violations ranging from copyright infringements (as detected with a Google web scrape) or serious childhood abuse cases detected by the sending of every uploaded photo through the MICROSOFT database described below.

The Lead Clash Sub-Engine produces special pages (see “Lead Class Sub-Engine” section below).

Book Sections

From Portions, the LifeBooks process renders chapters, sections, and other items for a memorial book. Typically, all LifeBooks, will include covers (front and back), a title page, one or more decorative pages, one or more end-pages, a table of contents, and appendices. Other kinds of pages, sections or items offered will not be used by all customers. Below are listed types of pages that may be rendered by the LifeBooks process.

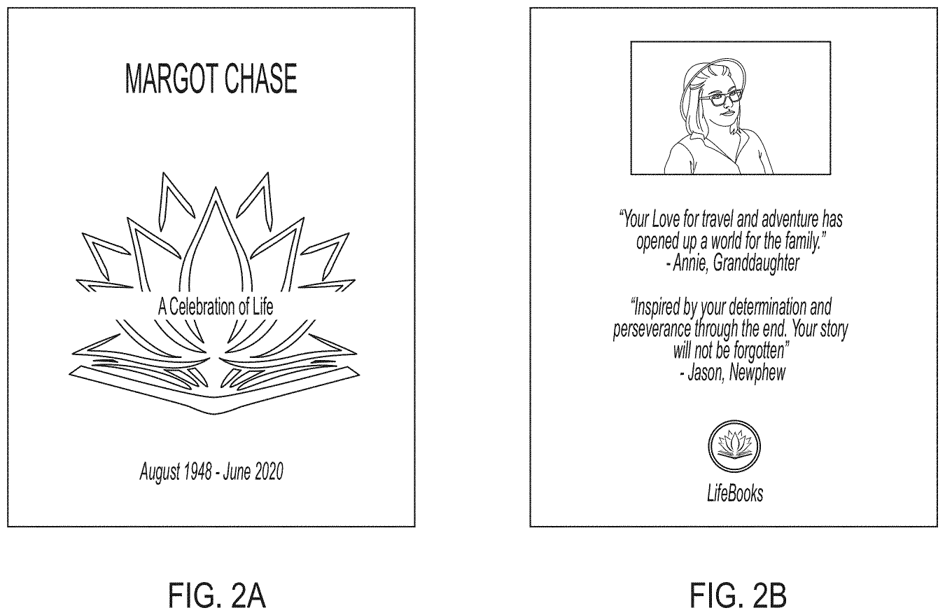

A front cover for a LifeBooks (see e.g., FIG. 2A). The front cover may include a logo, one or more names (e.g., name of deceased, persons being wed), years (e.g., date of birth and death), and a book slogan (e.g., “A Celebration of Life”).

A back cover (see e.g., FIG. 2B). The back cover may have images and quotes with high Prominence Engine scores.

Inner leaves which may have trademarked wall paper.

A publisher's page which, because of the custom and relatively small run nature of the LifeBooks, may have abbreviated pages.

A table of contents, generated by LifeBooks' in-house software.

A general obituary section (if a memorial LifeBooks), which typically is a page with a published obituary, in some instances amended, and a photograph of the deceased.

Eulogies (if a memorial LifeBooks) ordered by quality, with re-ordering options for the Client Lead.

Stories, text and in most instances, comprising pictures.

Maps, which typically show travels, places lived, and with indexes or lines pointing to images in maps, generated by a map-upload and map amendment User Interface.

Memories, typically text and in most instances, comprising pictures.

Family tree information, which are rendered sensitively, at times comprising blanks to be filled in where a family lacks data or for webbots to amend when accurate enough. Typically, the family-tree information is generated by off the shelf-technologies.

Timelines, which are often multi-Contributor enterprises, assigned to one who is encouraged to message around the group for accuracy and content.

Final words: Letters or writing by a deceased.

Honors and awards, typically a section of images and texts, especially fitting for veterans but also for career accolades or even “best Dad”-like remarks and photos.

Photos, which may include meta-data including who is in the photo and approximate date for indices, and to render auto-captions. Photo captioning may be generated by the individual uploading the photo or as an assignment or task taken-on by Contributors eager to do this critical task. Typically, photos are broken into user-defined sections, aided with suggestions, (e.g. “Early Life”, “Baby Photos”, “Ancestors”, “Teen Years”, “Sports”, “Travel”, “Homes”, “Home Life”, “Kids” etc.).

Poems, which are generally placed on pages with typography and/or light line art to enhance the appearance of the poem.

Memorable Quotations from the deceased (if a memorial LifeBooks), typically formatted for appreciation.

Writings by the deceased (if a memorial LifeBooks), which in some instances may be multiple pages and could include letters, postcards, or even academic work with labelling derived from the Contributors

Images produced by the deceased (if a memorial LifeBooks), particularly if the deceased was an artist or photographer. The context for such images may be provided in contribution descriptions and titles.

Social Media Sections, which may include posts, context on post, reproduced, and at times enhanced to improve appearance.

Religious Sections, which may be generated in consultation with religious experts to provide proper iconography, traditional prayers or epigrams, to stand alone or surround Contributor prayers.

Animation, typically with a first image of a continuous sequence captioned.

Recipes: uploaded from within a user interface for recipe editing, which may include placement of an image of a prepared dish or steps, an easy auto-find of free-stock images of ingredients to click-on for inclusion.

Guestbook section, which are rendered into attractive pages from the external tablets or computers displaying guestbook pages at memorials, weddings or other events.

Virtual Guestbook, which may include items that would be entered into the guestbook tablet/device for those not attending or for cases where no tablet/device was used to collect entries.

At least three Appendices, comprising an index of names, years, and keywords (derived from infrequent words when total word list is normalized for English (or book language) frequency); a list of contributors and the page numbers corresponding to their contributions; and key terms for images.

Sub-Processes/Engines

Sub-processes called “engines” implement, enable and facilitate the LifeBooks process by running sub-routines. A list of the engines and descriptions of the function and purpose follow.

Contributor Interface Services

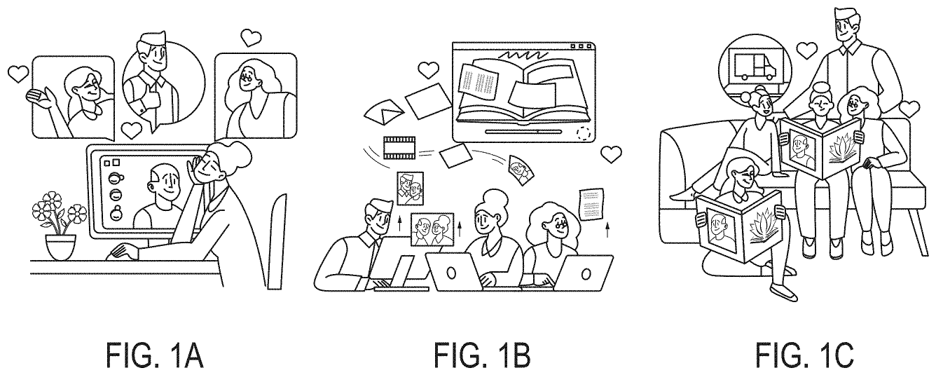

Referring now to FIGS. 1A-1C, therein is shown a diagrammatic representation of the functions of a Lead Set-Up Engine. The Lead Set-Up Engine assists in rapid sign-ups, importation of contacts/invitees from different platforms (e.g., social media platforms), selection of Contributors and/or Buyers, assignment of Portions, and forwarding of emails or direct messages to groups. FIG. 1A shows the first step of the LifeBooks set-up process, which begins with inviting family, friends or other individuals to contribute to a LifeBooks. The set-up process typically takes less than fifteen minutes to engage Contributors. FIG. 1B represents the second step of the set-up process, which comprises the invited individuals (Contributors) contributing photographs, stories, eulogies, etc. to the LifeBooks. The contributions are collected, organized, and formatted for print by the LifeBooks Engine. FIG. 1C represents the final step in the process from the Client Lead's perspective. The Client Lead hits the “send to print” button after receiving a notification from the LifeBooks Engine. LifeBooks then delivers a section sewn, hardbound heirloom to the Client's Lead and other Buyers, typically within 15 days of sending the LifeBooks to print.

Within the Lead Set Up Engine, a Personality Profiler, prompts a keyboard to enable quick selection and assigning features, automatic creation of welcome accounts for members, and a minimal information gathering option. Furthermore, the Personality Profiler sends messages to a group written by the process but amendable by Client Lead. The Client Lead sends out messages to the group to avoid spam traps (subsequent communication initiated by other group members do not suffer from the same spam risks).

The Contact Searching Sub-Engine comprises a contact searching feature. The contact searching feature assists in producing pre-drafted messages and guidance for contacts, and may use web-bots (e.g., SCRAPPY, PYTHON directed SELENIUM, etc.) to search the web for contact information and deliver the contact information to the Lead Dashboard.

The Lead Clash Sub-Engine is both a detector and conflict resolution process. Should it detect that more than one Client Lead has signed-up to do a book on the same subject, it issues an email to the potential Client Leads directing them to a Special Page with the options to (i) confirm the book subject, (ii) exchange contact information, and (iii) agree on one Client Lead. Where there is an agreement, the chosen Client Lead is declared the selected party and other accounts are suspended with appropriate Lead Dashboard notes informing all in the process of the decision. In some embodiments, the decision to designate a Client Lead is reversible by an invitation to communicate and return to the special Client Lead selector page. If there is a Client Lead change, notes are generated to inform Contributors of the Client Lead change within 48 hours.

In some embodiments, if the Client Lead candidates cannot agree on who should be the Client Lead, and none are in violation of the rules, each may be allowed to continue, because LifeBooks assiduously avoids family politics. In instances of multiple Client Leads, multiple LifeBooks may be produced. In other embodiments, the Client Lead candidates specify the relationship to the book's subject, and if a friend, the number of years of friendship and/or the number of friends closer or as close to the lead. If the number of friends close or closer to the lead is more than a preset number (e.g., 5 or 6), a support email is generated from the Lead Clash Sub-Engine.

Group members are sent emails or direct messages alerting them to the lead clash and may elect to participate in the LifeBooks led by the Client Leader each Group member chooses. The LifeBooks process does not adjudicate familial disputes such as those involving multiple marriages or other kith & kin rivalries—hence the informing but non-adjudicating role of this sub-engine.

The Assignment Recommender Sub-Engine derives data from the Personality Profiler to accelerate assignments by presenting default assignment list options to the Client Lead. It rather conventionally applies common sense coding to connect, for example, young kids to drawing assignments, coevals to memory texts, and long close relatives to older photos etc.

The Policy Compliance Checker Engine (typically, a Python-based engine) enforces policies and applicable law between the Client Lead and Contributors. The Policy Compliance Checker Engine monitors contributions and intervenes as necessary by employing the following sub-engines.

A. The Child Pornographic Abuse Sub-Engine checks photos from all contributors against child-abuse fingerprint databases and deals with the photos according to prevailing laws. Obscene, offensive, and pornographic photos are never published.

B. The Lead Relationship Filter Sub-Engine checks the subject of a LifeBooks against notable persons lists and alerts the Client Lead of name matches, giving the Client Lead the opportunity to indicate the name match is merely coincidental, or that there is a relationship with the notable person and, therefore, a celebrity book is permissible. Alternatively, options for making a fan book are presented. This sub-engine is typically managed via conventional ID checking methods used in the industry to prevent abuse. In some cases, an administrator and/or employees, possibly aided by ID engines, verify relationships through direct contact with celebrities to prevent abuse of celebrity-type books.

C. The Plagiarism Sub-Engine checks images and text against Google and other databases via Python scrapers. If identified and violates fair use, the Contributor of the material must declare copyright ownership, which is name checked. Again, LifeBooks is not run by idiots, and if abuse is a problem, there will be human interventions and elaborations of this engine, such as auto-emailing to copyright owner and clearance centers to verify true ownership or guidance for the Contributor to clear permissions which would be mediated by a special page for the copyright owner, and in the worst-case support tickets sent for human verification of policy compliance.

D. The Age Checker Sub-Engine checks the age of Contributors to avoid COPPA violations. The Age Checker Sub-Engine stops collections of underage Contributors, wends parents to a special page, requires an age check of the Client Lead and requests the Client Lead identify children and parents. The LifeBooks process does not collect meta-data for advertising from anyone under the age of 13 but does allow those under 13 to participate in the book. Information from those under the age of 13 is deleted along with all Contributor portions, typically within two weeks after books are delivered.

The Personality Profiler Engine derives demographic and personality data from the Client Lead, Contributors, or a directed web-bot (e.g., PYTHON SELENIUM) scraping social network and similar data. The Personality Profiler Engine also collects data unrelated to personality (e.g., time-zone data based on IP or addresses when user fills-out information. Output from the personality profiler engine is deployed into a variety of sub-engines/functions including the Assignment Recommender Sub-Engine, the Writer Assistant Sub-Engine and the Nudge Sub-Engine.

The Assignment Recommender Sub-Engine personalizes default assignments by web scraping Facebook and other social media to determine age and education and recommends sections which fit the Contributors or members of the Contributor's household to relevant sections such as memories sections for old friends or drawings for children. This informs and uses the Personality Profiler Engine.

The Writer Assistant Sub-Engine customizes writing assistance (e.g., assisting a 16-year-old is different than assisting a 60-year-old college professor). The Writer Assistance Sub-Engine comprises elements stored in the Web-App Front End and the LifeBooks Engine in the cloud running the central PYTHON 3.x controllers. The Writer Assistant uses demographic data to select appropriate prompts and skeletons for age, relationship and education and other personal data depending on availability. “Appropriate” as used here does not just mean difficulty, but the kinds of relationships possible, and further informs the empathetic sensitivity (e.g., sensitivity or excitement levels) of the interaction which is also modulated by the event type (i.e., memorial or celebration) which the Personality Profiler Engine and other engines maintain as a critical and obvious data point.

The Nudge Sub-Engine gently tracks and reminds Contributors via email and direct messages using novel contemporary psychological nudge techniques, and terms-of-art, which appeal to consistency, solidarity, social proof, and further in-house developed smart-timing, personality fitting reminders, and nudges from the Client Lead and other Contributors to get contributions completed and submitted. Once Contributors are assigned tasks, pre-set nudge schedules are initiated.

Typically, a LifeBooks creation can be completed in three weeks. In addition to ordinary reminders, if Contributor actions are not taken in a pre-set time (normally within three days), nudges (typically a maximum of three) are sent to encourage the Contributor to begin contributions. After, the Contributor begins and until the Contributor is done (as indicated by the Contributor hitting the “Done” Contributor Dashboard button) additional nudges are sent (typically a maximum of three more), and are prioritized for maximum impact, unless timing to the end date does not permit adequate time to complete the contributions (e.g., at least one day). In some instances, two reminders are timed for Monday afternoons (found to have maximum impact) or, for example, between 8 am and 11 am everyday but Fridays. Should the Contributor remain derelict, kith, kin and the Client Lead are encouraged to send reminders to the Contributor. The Contributor can opt out of nudges from their Dashboard or opt out entirely—the latter of which initiates a note to the Client Lead.

If there is more than one Contributor, the Nudge Sub-Engine initiates a notice to the Client Lead to designate a new Contributor from a New Contributor Special Page. Should the Client Lead elect not to do so, the account stays open (e.g., for a year or more), or until closed by the Client Lead, whichever comes first.

Client Leads typically have a pre-set deadline to finalize and hit the print button. Sometimes a Client Lead may be derelict and not complete finalization within the schedule. In such instances, the Client Lead may be sent nudges (e.g., biweekly).

In some embodiments, the first nudge is sent on a Monday (e.g., after a Sunday night deadline is missed), and subsequent biweekly emails are sent on Mondays and Saturdays, until the Client Lead unsubscribes or quits.

In some embodiments, the Nudge Sub-Engine has a concurrent option that may be activated by a Client Lead for a LifeBooks for an upcoming celebratory event such as a wedding. In such embodiments, the clock (typically, three weeks) starts after the event. In addition and before the event, a subset of pre-event contributors are nudged three times (typically on Mondays), with the third nudges emanating from “reminder to remind” emails sent to related kith and kin, but in a pre-written and auto-populated template to reduce workload. Such template typically may be modified by the reminding kith and kin. After the event, the Nudge Sub-Engine nudges per usual, with minor variations in the pre-written templates. In some embodiments, the Nudge Sub-Engine may be modified by the Administrator.

In the case of Buyers, the Nudge Sub-Engine encourages purchases (e.g., on Mondays between 8 am and 11 am local time as assessed by the Buyer's IP address).

The Predeceased Lead Engine allows a predeceased lead to initiate a book commemorating themselves. The predeceased lead designates another as the Client Lead, or the Client Lead is selected from an ordered list of Client Leads. If the first Client Lead on the ordered list is unwilling or unable to carry out his duties, or declines or fails as a lead (e.g., is a Derelict Lead—one who fails to complete an order in one year), then the next Client Lead may be selected from the ordered list.

Commemorative books can be created while the predeceased lead is alive, or it can be triggered by a “death-switch.” The death-switch is implemented by the Predeceased Lead Engine. The Predeceased Lead Engine may send regular, monthly emails or direct messages to the predeceased lead. If there is no reply, it increases contact frequency, moves onto other contacts, or can activate web-bots to search lists of the deceased. If the Predeceased Lead Engine determines the individual is deceased, it contacts Client Leads from the ordered list of Client Leads to find a cooperative Client Lead and commences the process at an appropriate time.

The Contributor Assistant Engine encourages the best contributions, provides space for brainstorming and outlining, along with prompts, spaced questions, and novel pre-written interactive skeletons of common events (e.g., eulogies and toasts) with blanks for the Contributor to fill-in details. In some embodiments, the Contributor Assistance Engine prevents more than one Contributor from using the same interactive skeleton for a LifeBooks. Alternatively, or in addition, the Contributor Assistant Engine may modify the interactive skeletons to match the Contributor's personality profile as determined by the Personality Evaluator Engine to cue and draw out the best secondary and tertiary contributions.

The Chaplain Engine includes a Chaplain's dashboard, which allows Chaplains to save data on their computers or in personal cloud storage systems for easy reuse of eulogies, wedding speeches, religious icons, and other user-defined data categories. The LifeBooks Total Privacy commitment integrated into the process, does not allow LifeBooks' Cloud Storage or any other system to save or mine portions of LifeBooks. Chaplains access their local data via a password on the Chaplain's dashboard which is very much like a conventional word processor pressed into the novel service of producing content for the LifeBooks process. Only the Chaplain's themselves have copies of their passwords.

Research into religions allows the process to facilitate Chaplains with gathering religious sect-appropriate templates, images, and basic bibliographic information of subjects (deceased or celebrating) from the Client Lead, the generic obituary or marriage announcement, communication with the Client Lead, and other helpful Portions (e.g., timelines). Like all Contributors, the Chaplain must be invited to participate.

In addition, the Chaplain Engine uniquely manages Contributors who necessarily span Groups. While all other Contributors can contribute to multiple groups for events, the Chaplain Engine provides special resources for this purpose and thus, from the beginning, spans class instantiations for groups.

The Lead Finalizer Engine is a combination of an accounting subprocess and an assistant that guides the Client Lead to the Print/Publish button. Throughout the process, the Lead Finalizer tracks contributions for balance, and calculates cumulative contribution volume, ensures that minimum book orders are filled, tracks buyers and contributors that have dropped out of the process, and tracks notices of process failures, such as infrastructure or supplier failures.

When all contributions have been submitted, or alternately, at a designated end-time, the Lead Finalizer Engine contacts the Client Lead (typically through email). The Client Lead is then guided through eight (8) final process steps on their Lead Dashboard:

(i) adding missing, desired contributions, especially distinctly critical ones (e.g., animations and content for a generic obituary or event announcement page);

(ii) deleting undesired material that may be flagged by the LifeBooks process as containing poor prose, poor photographs, objectional material and in some instances, if too many images or too much prose is submitted, deleting material, photos, and social media posts. Such deletion by the Client Lead is facilitated by the Prominence Engine's scouring of images and social media by likes;

(iii) editing sections and pages, and in some instances, portions. The Client Lead typically does only light editing in an editing mode, which includes a global find-and-replace feature. If more than light editing is detected, the Lead Finalizer Engine discourages the Client Lead from making edits by an “OK” check button to move on, and a reminder that the Client Lead does not bear the responsibilities of an editor—these are family books of high-quality, but also truthfully reflecting the imperfections of all families);

(iv) re-ordering chapters through an easy reordering option, comprising an up and down-sliding interface which, when confirmed, updates the Table of Contents Sub-Sub Engine;

(v) reviewing the front and rear covers with the capacity to select other photos or quotes. In some instances, selection of other photos and quotes, like editing, is discouraged by an “OK” check button to move on;

(vi) confirming that the Group has made the minimum order, offering check-out services for more LifeBooks and swag, and pre-written messages for the Client Lead to modify and direct to the most-likely buyers;

(vii) reviewing purchases; and

(viii) the opportunity to press the “Publish” button or delay submission (e.g., for a week).

Shortly (typically, a day) after the Publish button is pressed, a thank you note with an invoice, available tracking number, and anticipated delivery date is sent to the Client Lead, and an announcement by email and/or direct message with anticipated delivery dates and tracking numbers etc., is sent to all Buyers. The Lead Finalizer Engine implements processes to minimize time and effort by the Client Lead from easy keystroke navigation to fast drop-downs and flagging critical material.

The Swag Machine Engine allows Contributors to identify (typically in a text box) the best lines of their texts and best photos, thereby, together with the Prominence Engine's assessments, identifying high quality and “liked” portions for swag. The Swag Machine Engine (i) collects these “best-ofs”, (ii) uses vender APIs or in-house web-bots to produce images of swag (e.g., mugs, t-shirts etc.) on a Swag Dashboard, or solicits emails with links to dashboard markets, (iii) enables swag ordering, via vendor API's (a quick process since name and address information) is already known. Vendors are signed-on to protect content privacy before being allowed to sell wares. And, given the unique process (described below) for celebratory events, it is possible for amateur wedding planners or Client leads for similar events to, if production is fast enough, and delivery dates are indicated in ordering process, order large quantities for the relevant event. In typical embodiments, Contributors can order personalized swag with their own favorite images or text.

The Book Creator Engine functions to transform the liked portions into well formatted or in some instances, image enhanced items, not just for swag, but for creating memories to bring comfort to the grief stricken, or for creating memories for celebrity events.

The Coupon Engine generates and controls numbers, and processes coupon codes, tracks use of coupon codes, produces .csv files indicating use and information such as commissions for sales agents or auto-generated thank-you notes to coupon provider, which may in some instances, include more coupons. Generation is an administrator moderated process but could be connected to future automatic ad placement and solicitation targeting processes.

Technical Data Management & Book Creation Engines

The Collector Engine utilizes both a database management system (typically MySQL) and a cloud storage system (e.g., GOOGLE cloud storage). MySQL cannot store high quality animations or other large data sets reliably, without potential hacks. Because contributions and other information needs to be stored, accessed, and modified rapidly (portions are quickly converted into book items, sections and chapters), MySQL mainly acts as a pointer to data (although it may hold some light data) in cloud storage that is integrated into data files and forms to make books and format items for purposes ranging from swag to lead finalization display.

The Animation Bot Engine, like other engines, spans Web-App Front End dashboards and the code in the Cloud (typically, the code in the Google Compute Engine). At the dashboard level, the Animation Bot Engine guides the Contributor to upload and crop images for a flip-book animation. A flip-book animation is typically about 4 seconds duration, but in some instances may be a longer duration should the user opt to place multiple flip-books in a LifeBooks (a practice the LifeBooks process discourages). The flip-book animation is enhanced to maximally tickle the eyes' motion-contrast sensitivity function. This is achieved by weighting the 2D Fourier coefficients according to the contrast sensitivity function for motion. The frames default rendered in a non-distracting gray-scale box, roughly 2.5″ by 2.5″ in area (although other dimensions may be used) with the flexibility to reshape and accommodate diverse aspect ratios. Typically, the flip-book area ends near the bottom-right edge of the right page. Because the flip-books sequential images are nearly identical, it does not distract from the LifeBooks like a unique photo as one reads along but produces an animation (typically about 17 frames per second) bringing the subject to life, in ways designed to charm, inform for generations, and ameliorate the pains of grief in memorial books.

The Prominence Engine informs interface interactions (e.g., giving the lead input on the quality of contributions, which in turn informs balance and the LifeBooks quality, or giving authorized Chaplains, who are often overwhelmed with large flocks, useful tidbits about the subject of the LifeBooks). A Portion Quality Evaluator issues prominence scores, and judgements for text, including captions, social media (indications of popularity), and images automatically. Critically, the Prominence Engine collects information from various sources and using smart engines designed for commemorative books to do thousands of prominence and template-informed item and section ordering, sizing and placement as well as other adjustments, and bestows to the book creator (the Client Lead) some of the powers that would take a single (or even a team of ghost writers and template formatters) tens of hours to do or, in some cases, would be impossible to do. The Prominence Engine uses artificial intelligence (AI) for three aspects of book creation: (i) automated textual grading (writing scorers), (ii) automated photographic analysis (photo scores), and (iii) social media post analysis (e.g., counting likes, stars, retweets etc.). In some embodiments, off-the shelf, open-source code may be integrated to accomplish goals. Writing scorers have the capability to score text by measuring, as a poxy, diction and diversity, and photo scorers may use a combination of caption information terms indicating positive valanced terms, and well-known techniques (e.g., 1/f\hat{ }2 frequency analysis, color diversity, centrality of foreground and other techniques the administrator may utilize to provide a professional product). These automated scoring methods from sub-engines are combined into engines in the LifeBooks process to inform automated formatting of a LifeBooks, such as is done with the book creator's use of these scores to assign prominence to inform automated formatting decisions.

The Book Maker Engine, informed by the sub-processes of other engines, transforms Portions into book elements (items, sections, and chapters), sets content into book section templates, applies (typically, via Python controlled LaTex) state of the art typography, arranges and sizes images, fills in the front and back cover templates, paginates, produces appendices, and tables of contents, and then ensures all the content fits into the commemorative LifeBooks. Typically, a LifeBooks is approximately 100 pages.

An auto-formatting component of the Book Maker Engine is assisted by the Prominence Engine at two critical stages: (i) the initial layout; and (ii) through the Book Fitter Sub-Engine process. The general rule is a LifeBooks is formatted in chapters, which are pre-ordered by a book type template (e.g. table of contents, eulogies, Chaplain contribution, prayers, time lines, family trees, memories, social media, stories, photo pages), but optionally may be reconfigurable should the Client Lead desire. In some embodiments, one or more photos may be in sections with text (e.g., a Memory portion may be combined with a photo to make a section or chapter), and in further embodiments, caption text may accompany a photo. A Portion of the book may be a section or a chapter, depending on the list included with the Table of Contents. Main headings in the Table of Contents are chapters. An example of a section may be a particular eulogy. The length of the Table of Contents and whether it lists sections or not, is determined by length and a design template that limits the Tables of Contents (typically, to two facing pages).

A. The TOC Sub-Engine omits empty chapters when a LifeBooks does not have content for all chapters available. The Table of Contents typically occupies two facing pages and is rendered by the creation of a drawing from the Collector Engines data file (typically by a Python controlled LaTex function). If the TOC is too short for facing pages, fonts and spacing may shrink to accommodate both chapters and section titles. If section titles in a readable font in the most compressed form (from about a dozen formatting schemes) cause overflow beyond the two pages, the section titles may be omitted. In the very unusual case of many sections and few chapters, some sections such as the first eulogy, Chaplain's remarks, large named photo-sets from a single contributor can be elevated to chapters for aesthetic purposes. In some embodiments, the design may later be modified by administrator.

B. The Book Fitter Sub-Engine applies directed image adjustments to the custom pages and custom items (typically using a combination of Python directed LaTex™ and Python) informed by the Prominence Engine. The size, prolixity, photo submissions, social media submissions etc. varies considerably from group-to-group, and so the Book Fitter Sub-Engine may compress information or add to the page count by enlarging fonts and spacing.

Typically, the Book Fitter Sub-Engine adjusts, in order of priority, blank space size, decorations such as frame sizes, image sizes, font line spacing and font size, with recursion to minimize variation from ideal formatting. The Prominence Engine scoring ensures that the best items are shrunk last; for example, for the case of photos, good photos are the last photo items to shrink. In some embodiments, the Book Fitter Sub-Engine will negotiate the movement of especially high prominence score images and text to the custom back cover, to increase prominence and relieve page length restrictions either by minimizing size or eliminating the item(s) from inside the LifeBooks while transferring to the rear cover. The Book Fitter also maintains book balance so that photographs are generally less than 80% of the book and ideally about 30% of pages.

C. The Appendix Maker Sub-Engine typically produces three appendices for a LifeBooks and is informed mostly by the LifeBooks itself and Portion data such as Contributor names. The three appendices are an index of names, an index of years, and an index of keywords, derived from infrequent words after all words in the text, including social media posts, are normalized for English or book language frequency. The Appendix Maker Sub-Engine places names and names other than the subject(s) that near the top ten percentile of most repeated names (likely to be close kith and kin) in an appendix, lists Contributors and the page numbers corresponding to their contributions and lists key terms from image captions and titles with page numbers for easy photo look-up. In some embodiments, parameters could be changed by the Administrator in response to feedback and review.

D. The Cover Formatter Sub-Engine performs the delicate job of formatting covers. For celebrations, images of an event or the subjects of the event are on the front and back covers. For memorial books, research finds that the deceased on the front cover is uncomfortable for the grieving. Consequently, in typical embodiments, the Prominence engine and sometimes the Book Fitter suggests front and back cover images, while the Client Lead may have the final say. The quotes on the front or back cover are similarly suggested. Examples of front and back covers are shown respectively in FIGS. 2A and 2B.

Post Book Design Process Engines

The Printing and Shipping Engine are a pair of simple APIs provided by printing and shipping vendors.

The Deleter Engine offers the valuable novel utility of deleting a book's content (typically deleted approximately 14 days after delivery) to prevent content mining and hacking. The Deleter Engine not only deletes books, but also all portions. Chaplain dashboards are saved locally, and Contributors may import similar plug-ins to their dashboards, but the LifeBooks process and Cloud Storage retain only contact information, securely encrypted, and none of the book content that is produced.

Improvement and Advertising Process Branches

Feedback data systems for ads and survey results constitute post-production processes of soliciting and organizing survey results via email or direct messages to subsets of customers for improvement. Also, dashboards can display via the Web-App Front End, branches of the LifeBooks process which collect scores on interfaces and usage data anonymized and saved in the Cloud Storage for Administrator or machine learning optimizations.

In some embodiments, the process may implement web-bots to monitor for customer, Contributor, Buyer, Client Lead, and other individuals (but not individuals drawn from book portions, since these are off-limits before and after erasure), to find and solicit when such individuals suffer or enjoy events that LifeBooks may improve.

The LifeBooks Process

Lead Sign-Up Process

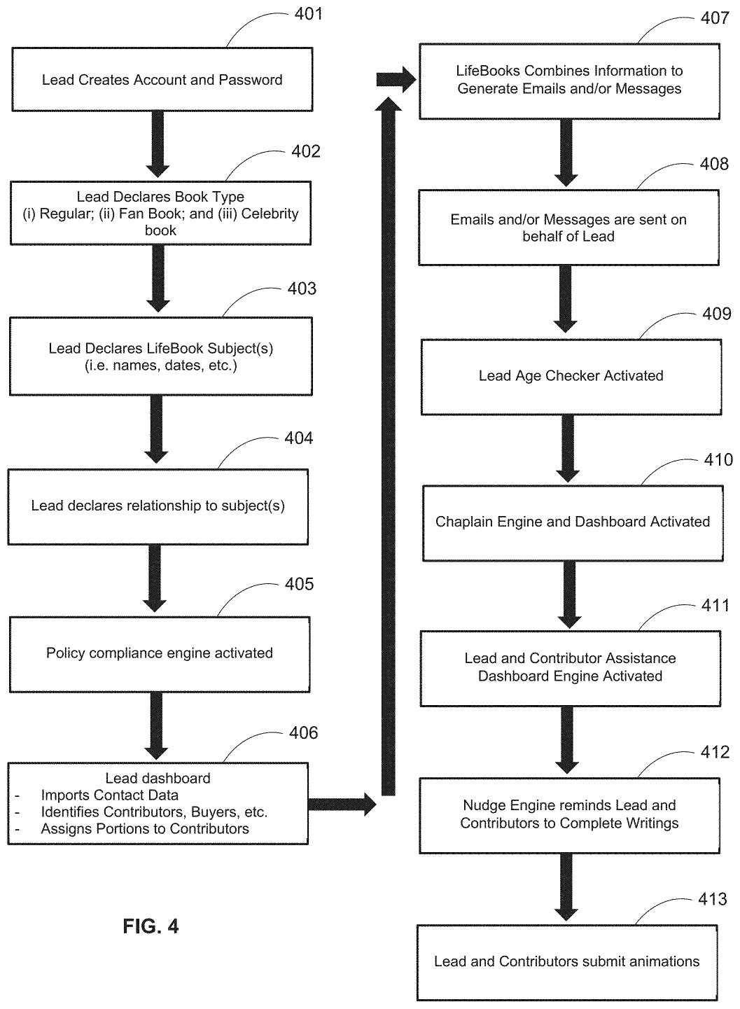

Referring now to FIG. 4, therein is shown a Lead Sign-Up Process according to an embodiment of the invention. The Lead Sign-Up Process begins at Step 401 when the Client Lead signs up via creation of an account and password with email verification. At Step 402, the Client Lead declares the book type from three main categories of LifeBooks: (i) Regular; (ii) Fan Book; and (iii) Celebrity book, and sub-categories of (a) Memorial or Celebratory, and if memorial, Memorial Lead, or Death-Switched Predeceased Lead.

At Step 403, the Client Lead declares the LifeBooks subject(s) (e.g., the name and dates of the deceased, names of those marrying, names of key individual(s) celebrated in an event, etc.). Depending on the embodiment, the title of the LifeBooks may or may not include names. At Step 404, the Client Lead declares the relationship to the subject(s) of the Life Book. Also at Step 404, if more than one Client Lead completes the Sign-Up Process, the Lead Clash Engine may also be activated (not shown in FIG. 4) to determine which one, or whether more than one individual will fulfill the role of Client Lead.

At Step 405, the Policy Compliance Engine and its four sub-engines (Child Pornographic Abuse Sub-Engine, the Lead Relationship Filter Sub-Engine, the Plagiarism Sub-Engine and the Age Checker Sub-Engine) are activated.

At Step 406, the Lead Dashboard guides the Client Lead to: (i) import contacts and/or emails and select group invitees; (ii) identify Contributors, Buyers and Contributor-Buyers; and (iii) assign portions to Contributors.

At Step 407, the LifeBooks process combines best-fit templates filled with Client Lead information related to age, relationship to subject and/or Personality Profiler Engine information to generate emails and/or direct messages containing invitations, confirmation numbers, links to dashboards, description of LifeBooks, legal information and an opt-out option link, which alerts the Client Lead and subtracts member(s) from group.

At Step 408: emails and/or direct messages are dispatched from the Client Lead (either by conventional means or newer html5's email activations); the Client Lead is invited to contribute to the LifeBooks; the Client Lead is congratulated and directed to the Web-App Front End shopping cart to purchase a minimum of one LifeBooks; and the once purchased, the Client Lead is sent a thank you note.

At Step 409, the Lead Age Checker is activated to send an “Under 13” checkbox to every invited person, including the Client Lead. At Step 410, if a Chaplain is identified, the Chaplain Engine and Dashboard are activated, and a template befitting the Chaplain recipient is forwarded (typically by email) selling LifeBooks services and products, and in some embodiments, including coupon codes.

In embodiments where the Client Lead writes, At Step 411, a writing Dashboard is produced to the Client Lead and the Contributor Assistance Engine is activated. At Step 412, the Nudge Engine Activates to remind the Client Lead or Contributors to complete writings.

At Step 413, if the Client Lead or Contributors submit animations, the Web-App Front-End collects the animations, and provides pre-build cropping and guidance for uploading the animations. The pre-build guidance may include an indication of items to be uploaded, (e.g., for memorials, images of participating in activities the deceased loved when alive).

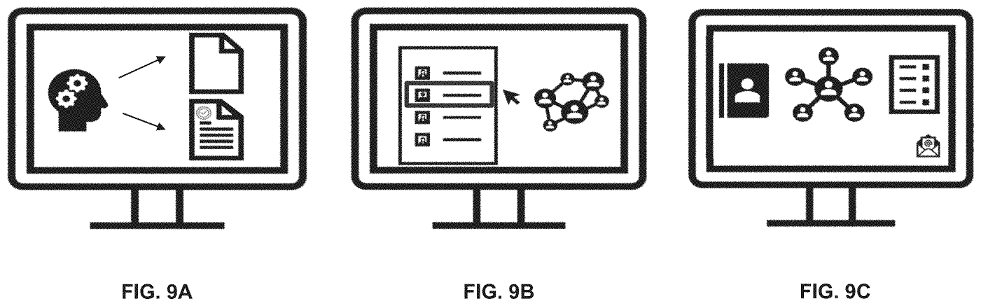

The Lead Sign-Up process is also shown diagrammatically in FIGS. 9A-9C. Referring first to FIG. 9A, the Client Lead receives a log-in with instructions setting forth the two main responsibilities of the Client Lead, specifically, set-up and final editing (which is typically, redaction only). Referring to FIG. 9B, contacts are uploaded for identification of Contributors, Buyers and Contributors/Buyers. The Client Lead uses a mouse, or preferably a keyboard, to quickly identify Contributors and likely Buyers. The Client Lead may have the option to add names and email addresses manually, if any are missing or access to certain contacts is denied. Typically, only email addresses are required because Contributors and Buyers may provide their own, detailed personal information. Only the contacts selected as Contributors, Buyers and Contributor/Buyers are saved. The contact book itself is not saved by LifeBooks.

Referring now to FIG. 9C, the Client Lead sets general settings (e.g., the Client Lead declares book type (e.g., memorial, wedding, other events and regular, fan book or celebratory book type). Typically, the Client Lead uploads of an obituary, his or her ID, and a signature declaring a relationship to the book's subject (e.g., from a list of kin relations, or the Client Lead may specify years of friendship and closeness of friendship by declaring the approximate number of friends closer to subject of the LifeBooks than the Client Lead is to the subject). If there are more than five friends closer to the subject than the Client Lead, a support email is generated. The Client Lead also sets settings relating to religion and level of desired iconography. However, prayer sections allow Contributors to set iconography for specific prayer sections.

The Client Lead also assigns one or more sections to contacts along with an optional note. The Contributor Dashboard then tells Contributors that they do not have to but are encouraged to fulfill assignments. Assignments range across all sections and include images such as social media images. Multiple emails are produced to send to Contributors and potential Buyers, which are sent from the Client Lead's account to get around spam filters.

Contributors Collection Process

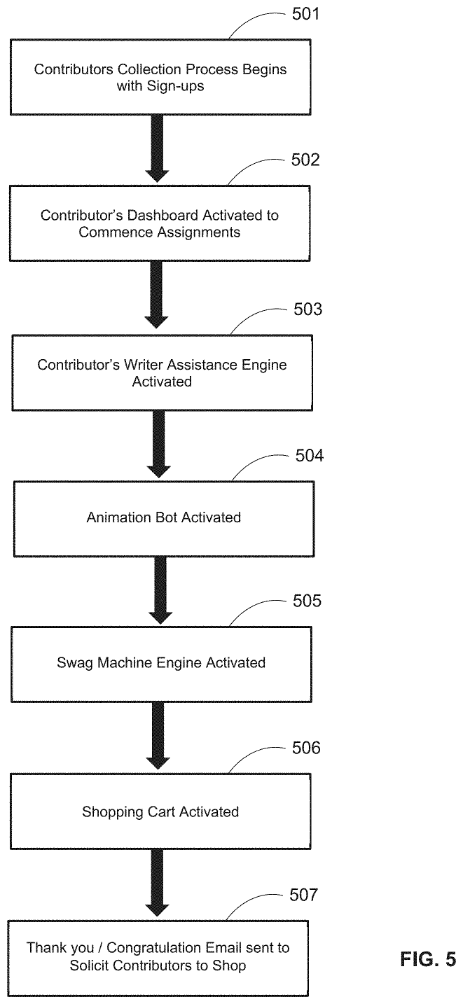

Referring now to FIG. 5, therein is shown a flowchart of the Contributors Collection Process, according to an embodiment of the invention. The Contributors Collection Process starts at Step 501, with Contributors, Buyers, Buyer-Contributors and Chaplains (if applicable) signing up on respective Dashboards.

At Step 502, Contributors use their respective Dashboards to commence assignment(s) or self-selected Portions. Contributors may upload media, and if writing, the writing is sent to that Contributor's Writing Assistance Dashboard. At Step 503, the Contributor Assistance Engine is activated, which acts as a hybrid machine-human assistance process. The process is non-deterministic and non-algorithmic (in the sense that humans are not treated as governed by algorithms), and thus produces a cyborg writing contribution.

Typically, as part of the Contributors Writing Assistance Dashboard, Contributors have fast caption writing screens, which show images uploaded by the Contributor or assigned to the Contributor for captioning. In typical embodiments, images populate down a single window, and contain directions, a variety of interactive caption boxes underneath each image with checkboxes and autocomplete function for names used. Striking a check box for a name list produces blanks for fast tab name filling, with “from left to right” and similar helpful common copy auto-filled, a second text box for a description, a branched drop-down table for the year, and location spellchecking for a location box. The Contributors Writing Assistant Dashboard informs the Book Creator's caption formatting and the Appendix Maker's photo index.

At Step 504, an Animation Bot is activated (if uploading images or video for animation). At Step 505, a Swag Machine Engine provides a Swag Dashboard allowing Contributors to pick swag from photos and text.

At Step 506, a Shopping Cart is activated to allow for the purchase of swag. At 507, and after the completion of a LifeBooks, a solicitation email is sent to the Contributor with a “thank you” and “congratulations.

Throughout, the Contributor process, the Client Lead receives progress alerts (not shown in FIG. 5) on the Lead Dashboard and via email (if opted in) to provide the Client Lead with information on book purchases, contributions done, total words of different section types, total photographs submitted, a balance meter (typically, aiming for between 30% and 80% photos. Although information on balance is provided to the Client Lead, the Book Fitter Engine also performs balancing.

Throughout the Contributor Process, the Lead may use a Tablet (or other personal computing device) to activate the Tablet Guestbook Dashboard for an event (also not shown in FIG. 5). A Client Lead password is required to activate and submit the Guestbook. The Client Lead is encouraged with instructions to use SCREEN TIME or other Parental lock-like features so only a web-browser showing the Guestbook is open, and to provide a stylus.

LifeBooks Interface/Interactive Text Editor

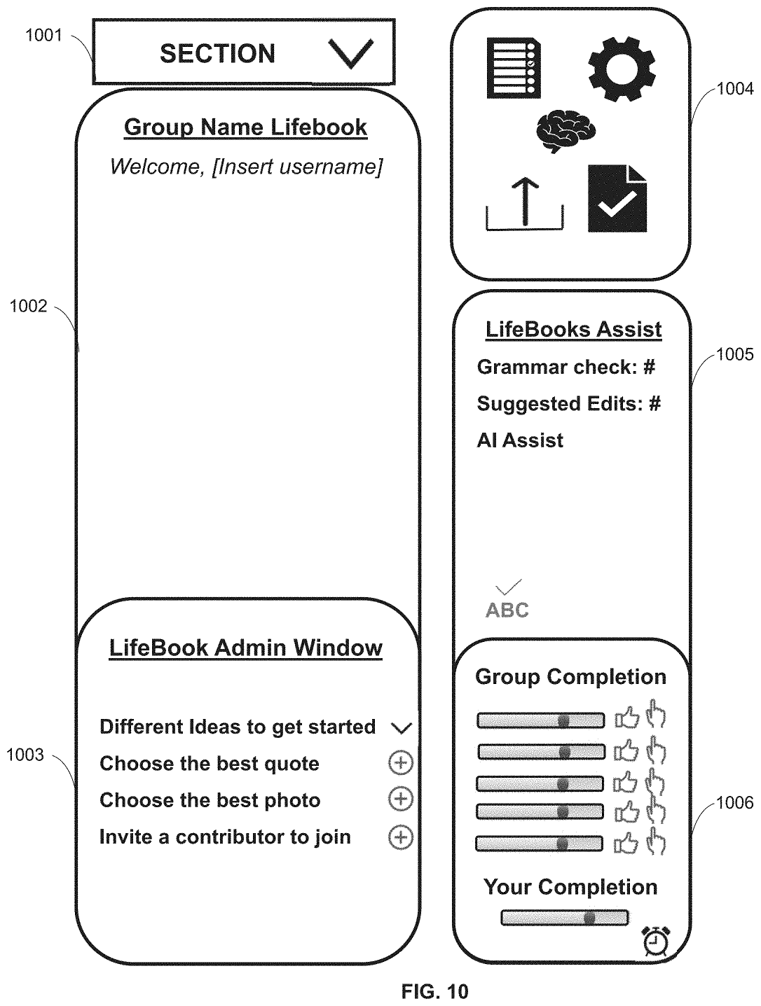

Contributors are often uncomfortable writing, and the LifeBooks dashboard for assisting writing provides guidance, which may be calibrated for the Contributor with input from the Personality Profiler. Referring now to FIG. 10, therein is shown a LifeBooks Interface/Interactive Text Editor, in a two column format, according to an embodiment of the invention.

The first column includes three boxes 1001, 1002 and 1003. Box 1001 selects the section types, each of which is formatted differently. In some embodiments, formats will be reflected in the box below where the writing occurs. Contributor's progress suggested sections and sections in progress or completed are also noted. Box 1002 provides space for writing. If writing a caption, the relevant images to caption may appear in this box. Typical throughout the LifeBooks Interface/Interactive Text Editor, total keyboard navigation is possible and turned on the same way throughout the system, in some instances via a hot key (e.g., cmd-? will show keyboard hotkeys if not displayed).

Box 1003 is an administrative window, which may include options and ideas for getting started and may present in grey text, giving the Contributor an option to delete beginnings, middles, and endings of text suggestions. Included also in Box 1003 are: (i) a best quote button, allowing a Contributor to put in the best pieces of text in their contribution and rank text from other Contributors; (ii) best photo button, allowing a user to rank photos uploaded and/or other photos; and (iii) a button inviting a contributor to join, which opens a chat window for real time or asynchronous messaging between Contributors, and options such as copy and paste.

In the second column, there are also three Boxes 1004, 1005 and 1006. Box 1004 contains symbols that provide for toggling and/or instructions. There are three modes for the LifeBooks Interface/Interactive Editor Text, namely writing, outlining and brainstorming. Brainstorming is shown in Box 1004 represented by the “brain” symbol, writing is shown by the “page” symbol with lines. Outlines are not shown in Box 1004, but may be provided in Box 1005, in the empty space under the “AI Assist.”

The “gears” symbol in Box 1004 provides settings, including toggling or instructions for toggling the between browser and LifeBooks grammar and spellcheck. It also controls whether the Contributor desires to keep items private from all but Client Lead (default), toggles the group progress information center, offers options for language, emojis, contains section-related options such as religions iconography, and other options. The LifeBooks' spellcheck has names relevant to the group and auto-complete options for dates connected to key words. The “upload” symbol in Box 1004 (the symbol containing the upward arrow), is for uploading media and takes a Contributor to appropriate upload screens, or in some instances, if the upload is single or multiple images, which the Contributor is captioning, the screen may display the images horizontally on top of a writing box designed to collect key photo information including date, location, persons, and additional caption. Caption is auto populated in gray instantly with the key photo information written out, to save duplicate typing and so the Contributor may view what will be seen. Even if key photo information is left out of the caption box it is stored for appendices and other services which may use the data. Also in Box 1004, is a check-box, which indicates completion, and includes ordinary features such as saving, save requests, reminders if box is closed without saving and ordinary document management.

In Box 1005 is a LifeBooks Assist Center to give interactive feedback and suggestions, which may, in some embodiments, show the number of grammar checks and the number of suggested edits remaining. The AI Assist button in Box 1005, activates open-source advanced text completion services (e.g., GPT-3), text generators, and other transformer API options. The “ABC check” button in Box 1005, indicates a final grammar and spelling check.

Box 1006, a “Group Completion” box, shows the progress of the group of Contributors to assist with maintaining motivation. The “Your Completion” bar shows completion for assignments assigned and accepted by the Contributor. In some instances, the completion may exceed 100% (e.g., if the Contributor does more than is assigned).

Buyer Process

The Buyer Process is a simple one. Buyers only see a shopping cart for books after a LifeBooks purchase option is presented. Buyers mainly engage with products and shopping cart front end features.

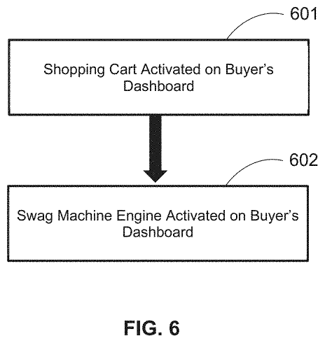

Referring to FIG. 6, therein is shown a flow diagram for a method for Buyer's process, according to an embodiment of the invention. At Step 601, a Shopping Cart appears on a Buyer's Dashboard, presenting Buyer with an option to purchase one or more LifeBooks.

At Step 602, a Swag Machine Engine is activated, giving Buyers an opportunity to purchase swag on the Buyer's Dashboard.

The LifeBooks Process offers a novel and unique concurrent process option for celebrations and weddings, which produces automated, custom, commemorative books by overcoming barriers to participation such as (a) waning interest after the celebratory event, (b) recruiting those who cannot attend to participate to express themselves, and (c) provides content glimpses from the separate and then united kith and kin of the wedding party. All of which produce a (i) better book and (2) book made better, in that it is appreciated more during the production process and as a final product because it has utility as something which better bonds the newly joined kith and kin of the wedding or similar event.

Generally, when the Client Lead picks a celebratory event for a concurrent process, options open-up, first to determine the events date and to schedule a before, during and after process. Before such events a subset of pre-event Contributors and assignments are identified and selected by the Client Lead and activates the concurrent mode of the Nudge Machine. At the event, the Guestbook is present, and a set of Contributors are selected for assignments related to event reporting, such as collecting copies of toasts, and recording video for the flipbook, finally a third set of post-event Contributors are invited and assigned appropriate assignments. The same Contributors can participate in any subset of these stages. Sales and shopping carts are unchanged except that if there is adequate time, the Swag Engine will suggest bulk order swag to the Client Lead if it can be delivered on time for the event.

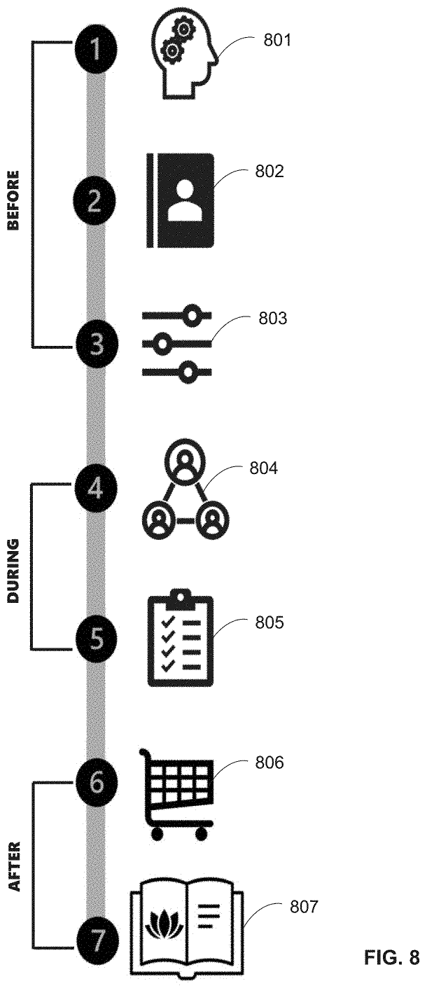

A concurrent process (a before, during and after process) is set forth diagrammatically and more specifically in FIG. 8. The concurrent process option works as follows: Before the event at 801, the Client Lead picks a celebratory event and initiates a LifeBooks. At 802, the Client Lead indicates the type of celebratory event (e.g., a wedding) and whether the LifeBooks is a Regular book, a Fan book, or a Celebrity Book. Concurrently, or nearly concurrently, the Lead Set Up Engine checks to be sure the subject(s) of the LifeBooks are not a notable person or person. If a notable person is the subject, then further verifications are initiated. The LifeBooks/Lead Set Up Engines then receives an upload of ID and signature from the Client Lead declaring his or her relationship to the book's subject from a list of kin relations. At 803, The Client Lead inputs an event date, selects nudge timelines and related logistical settings, including upload of an invitation list to email contacts for initial mailings. Before the event a subset of pre-event Contributors and assignments are identified and selected by the Client Lead, which activates the concurrent mode of the Nudge Machine. If there is adequate time, swag orders for delivery at the event can be ordered by Client Lead or other invitees (Buyers or Contributors).

The “at the event” process includes: At 804, a set of Contributors are selected for assignments to be performed at the event, which are related to event reporting, such as collecting copies of toasts, and recording video for the flip-book. At 805, and at the event, the Life-Books' front end runs a dashboard, which looks and acts as a Guestbook, typically displayed as a tablet, preferably with a stylus. Information is collected and uploaded to Cloud storage for the “Guestbook” section of the LifeBooks.

After the event, at 806, a last call for Contributors and Buyers goes out because more can be added, and a last call for purchase of LifeBooks and swag goes out. Finally, at 807, the Client Lead redacts and sends the LifeBooks to printer. Swag delivery is handled by swag third parties with input from the LifeBooks Engine in cases where delivery is time sensitive.

Book Creation Process

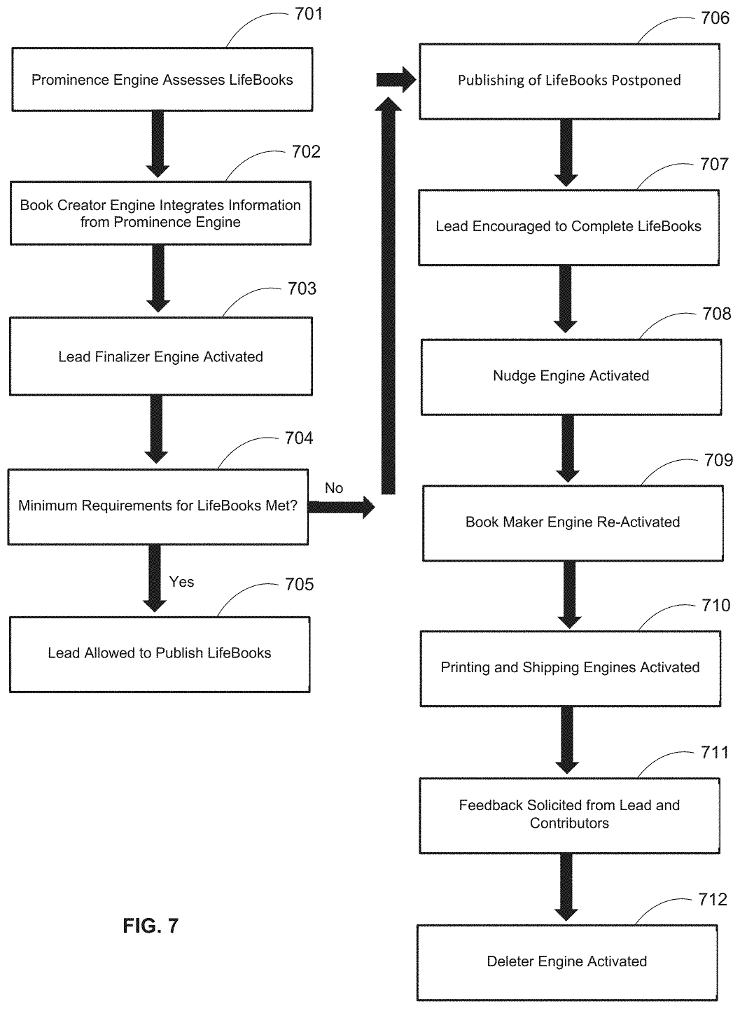

Referring now to FIG. 7, therein is shown a flowchart of a method for the LifeBooks creation process. At Step 701, the Prominence Engine ranks, grades and rates Portions for the LifeBooks. At Step 702, the Book Creator Engine integrates information from the Prominence Engine, transforming Portions into items, sections and chapter. The Book Create Engine is assisted in the Book Creation process by its sub-engines, specifically (i) the TOC Sub-Engine, (ii) the Book Fitter Sub-Engine, (iii) the Appendix Maker Sub-Engine, and (iv) the Cover Formatter Engine.

At Step 703, the Client Lead is notified to return to the Lead Dashboard, which is animated by Front-End code and the Lead Finalizer Engine. Changes to the LifeBooks are captured and stored. At Step 704, it is determined whether the minimum requirements for the Life Book are met. At Step 705, if the minimum content has been submitted and has adequate balance, and the minimum order quantity is satisfied (minimum quantities may vary from at least 1 to as many as 20 LifeBooks depending on the nature and size of the LifeBooks), the Client Lead pushes the publish button and the LifeBooks is published.

If the minimum criteria are not satisfied, at Step 706, the publication is postponed. At Step 707, the Client Lead is sent a gentle reminder to encourage the Client Lead to complete the process.

If the Lead is derelict or doesn't finalize within a prespecified time after the reminder is sent (typically three days), at Step 708 the Nudge Engine is activated to send additional gentle nudges to the Client Lead.

If the Lead finalizes, at Step 709, the Book Maker Engine is re-activated to integrate changes implemented by the Client Lead during finalization—a fast automated process.

Then, at Step 710 the Printing and Shipping Engines are activated. Once printed and shipped, and after receipt of the LifeBooks by the Client Lead and Buyers, at Step 711, feedback is solicited from Client Lead, Contributors, Chaplains and Buyers via email. At Step 712, and after a preset amount of time after books are delivered (typically fourteen days), the Deleter Engine activates.

If the LifeBooks are damaged in shipment or suffer production issues, human support is alerted. New books or refunds are sent out, a process that is human mediated. If there is an issue with damaged products, activation of the Deleter Engine may be delayed.

If insufficient feedback is received (see Step 711), then feedback may again be solicited from a subset of users (not shown in FIG. 7).

The process employs web-bots to monitor events for adult users that may be potential customers. LifeBooks may send solicitations or ads to these promising customers, unless, of course, they opt out of such ads.

In some embodiments, a method for producing a LifeBooks comprises: (i) receiving at a computer operably coupled with a memory and instructions for implementing the method, a request from a predeceased lead to implement a death switch, comprising a death detection trigger for creation of content; (ii) sending first messages to the predeceased lead at intervals; (iii) detecting whether a response to the first message is received within a specified time period; (iv) in response to detecting that a response is not received within the specified time period, sending at least one secondary message; (v) detecting whether a response to the at least one secondary message is received within a specified time period; (vi) in response to detecting that a response to the at least one secondary message was not received within the specified time period, compiling at least some textual, audio, pictorial, and/or video data into a publication.

In some embodiments, the at least one secondary message is sent to the predeceased lead. In some embodiments, multiple secondary messages are sent at more frequent intervals than the first messages. In further embodiments, multiple secondary messages are sent at more frequent intervals than the first messages, and in even further embodiments, the at least one secondary message is sent to secondary contacts.

In some embodiments, the method comprises: (i) receiving at a computer operably coupled with a memory and instructions for implementing the method, a request from a predeceased lead to implement a death switch, comprising a death detection trigger for creation of content; (ii) sending first messages to the predeceased lead at intervals; (iii) detecting whether a response to the first message is received within a specified time period; (iv) in response to detecting that a response is not received within the specified time period, accessing at least one database of deceased persons; (v) detecting whether the database contains data indicating that the predeceased lead has become deceased; and (vi) in response to detecting that the predeceased lead has become deceased, compiling at least some textual, audio, pictorial, and/or video data into a publication.

In yet other embodiments, the method may comprise: (i) receiving at a computer operably coupled with a memory and instructions for implementing the method, data from a first data source; (ii) confirming that the data meets at least one specified parameter, and in response to a positive determination, recording the data in a database, where a unique signature identifying the data is generated; (iii) purging the data from the database after publication of at least some textual, audio, pictorial, and/or video data; (iv) resending data from the first data source to the computer after the purge; (v) generating by the computer, a signature identifying the data; (vi) the computer comparing the data from the computer to a database of signatures; (vii) the computer determining whether the signature already exists in the database; and (viii) in response to determining that the signature already exists in the database, adding the data back to the database without confirming that the data meets at least one of the at least one specified parameter.

In some embodiments, the at least one specified parameter is bitrate for audio or video data. In other embodiments, the at least one parameter is a lack of pornographic content. In yet other embodiments, the at least one parameter is writing of a specified quality level.

What is claimed is:

1. A method comprising:
receiving at a computer operably coupled with a memory and instructions for implementing the method, a request from a predeceased lead to implement a death switch, comprising a death detection trigger for creation of content;
sending first messages to the predeceased lead at intervals;
detecting whether a response to the first message is received within a specified time period;
in response to detecting that a response is not received within the specified time period, sending at least one secondary message;
detecting whether a response to the at least one secondary message is received within a specified time period;
in response to detecting that a response to the at least one secondary message was not received within the specified time period, compiling at least some textual, audio, pictorial, and/or video data into a publication

2. The method of claim 1, where the at least one secondary message is sent to the predeceased lead.

3. The method of claim 2, where multiple secondary messages are sent at more frequent intervals than the first messages.

4. The method of claim 3, where multiple secondary messages are sent at more frequent intervals than the first messages.

5. The method of claim 1, where the at least one secondary message is sent to secondary contacts.

6. A method comprising:
receiving at a computer operably coupled with a memory and instructions for implementing the method, a request from a predeceased lead to implement a death switch, comprising a death detection trigger for creation of content;
sending first messages to the predeceased lead at intervals;
detecting whether a response to the first message is received within a specified time period;
in response to detecting that a response is not received within the specified time period, accessing at least one database of deceased persons;
detecting whether the database contains data indicating that the predeceased lead has become deceased; and
in response to detecting that the predeceased lead has become deceased, compiling at least some textual, audio, pictorial, and/or video data into a publication.

7. A method comprising:
receiving at a computer operably coupled with a memory and instructions for implementing the method, data from a first data source;
confirming that the data meets at least one specified parameter, and in response to a positive determination, recording the data in a database, where a unique signature identifying the data is generated;
purging the data from the database after publication of at least some textual, audio, pictorial, and/or video data;
resending data from the first data source to the computer after the purge;
generating by the computer, a signature identifying the data;
the computer comparing the data from the computer to a database of signatures;
the computer determining whether the signature already exists in the database; and
in response to determining that the signature already exists in the database, adding the data back to the database without confirming that the data meets at least one of the at least one specified parameter.

8. The method of claim 7, where the at least one specified parameter is bitrate for audio or video data.

9. The method of claim 7, where the at least one parameter is a lack of pornographic content.

10. The method of claim 7, where the at least one parameter is writing of a specified quality level.
